(19) United States
(12) Patent Application Publication
(10) Pub. No.: US 2010/0115160 A1
(43) Pub. Date: May 6, 2010

(54) SYSTEM FOR TRANSFERRING A FILE BETWEEN ASSOCIATED COMPUTERS

(75) Inventor: Ching-Wei Cheng, Keelung (TW)

Correspondence Address: ROGER H. CHU, 19499 ERIC DRIVE, SARATOGA, CA, 95070, US

(73) Assignee: Action Star Enterprise Co., LTD., Sijhih (TW)

(21) Appl. No.: 12/576,288

(22) Filed: Oct. 9, 2009

Related U.S. Application Data
(60) Provisional application No. 61/109,566, filed on Oct. 30, 2008.

(51) Int. Cl. G06F 13/12

(52) U.S. Cl. 710/73

(57) ABSTRACT

A system for transferring a file between associated computers is provided. The system comprises a micro control unit; a first USB interface coupled between the micro control unit and a set of keyboard, monitor and mouse; a second USB interface coupled between the micro control unit and a plurality computers; and a switching mechanism for switching the set of keyboard, monitor and mouse coupled to on of the computers to another; wherein the micro control unit including a buffer for registering a file from one of the computers and then transferred to other one of the computers.

### CROSS REFERENCE TO RELATED APPLICATIONS

This application claims priority from a co-pending U.S. Provisional Patent Application Ser. No. 61/109,566 filed Oct. 30, 2008, the entire content of which is incorporated herein by reference.

### BACKGROUND OF THE INVENTION

1. Field of the Invention

The present invention generally relates to a keyboard/mouse (KM) device for transferring a file between a plurality of computers, more particularly to a system for transferring a file between associated computers.

2. Description of the Prior Art

There exist devices for interconnecting a single computer to multiple computers. For example, a keyboard/video/mouse (KVM) switch is a device that is generally connected to multiple computers in order to enable a single keyboard, video monitor and mouse to control each of the connected computers. In this way, a user may have access to multiple computers without having to invest in corresponding keyboards, monitors, and mice for each of the computers. When the user accesses a computer connected to the KVM switch, video signals are routed from the computer, processed, and displayed on the single video monitor.

FIG. 1 illustrates function blocks of a conventional KVM device. Referring to FIG. 1, the KVM device comprises a KVM switch for connecting a set of monitor, keyboard and mouse to control the PCs (computers) coupled to the KVM switch. The KVM device also comprises a plurality of hubs connecting between associated computer and the KVM switch. For transferring a file from first computer to second computer, the KVM device further comprises data transfer units connected between the adjacent hubs. The file from the first computer can be transferred to the second computer through the data transfer unit connected between the hubs associated to the first computer and the second computer.

For the KVM device speaking, if the KVM device controls five computers by one set of monitor, keyboard and mouse to control, there should be four data transfer units built in the KVM device for transferring files between associated computers. The more computers controlled by the KVM device, the more data transfer units should be added. Thus, the cost and the size of the KVM device must be increased.

It is desirable, therefore, to provide a low cost and small sized KVM or KM device to allow for transferring files between computers associated to the KVM or KM device.

### SUMMARY OF THE INVENTION

The primary objective of the resent invention is to provide a low cost system for transferring a file between associated computers. The system comprises a micro control unit; a first USB interface coupled between the micro control unit and a set of keyboard and mouse; a second USB interface coupled between the micro control unit and a plurality computers with associated monitors; and a switching mechanism for switching the set of keyboard and mouse coupled to one of the computers to another; wherein the micro control unit including a buffer for registering a file from one of the computers and then transferred to other one of the computers.

The other embodiment of the present invention is to provide a system for transferring a file between associated computers. The system comprises a micro control unit; a first USB interface coupled between the micro control unit and a set of keyboard, monitor and mouse; a second USB interface coupled between the micro control unit and a plurality computers; and a switching mechanism for switching the set of keyboard, monitor and mouse coupled to on of the computers to another; wherein the micro control unit including a buffer for registering a file from one of the computers and then transferred to other one of the computers.

Other and further features, advantages and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates function blocks of a conventional KVM device.

FIG. 2 illustrates function blocks of the system of the present invention.

FIG. 3 illustrates another function blocks of the system of the present invention.

FIG. 4 illustrates further function blocks of the system of the present invention.

### DETAILED DESCRIPTION OF THE INVENTION

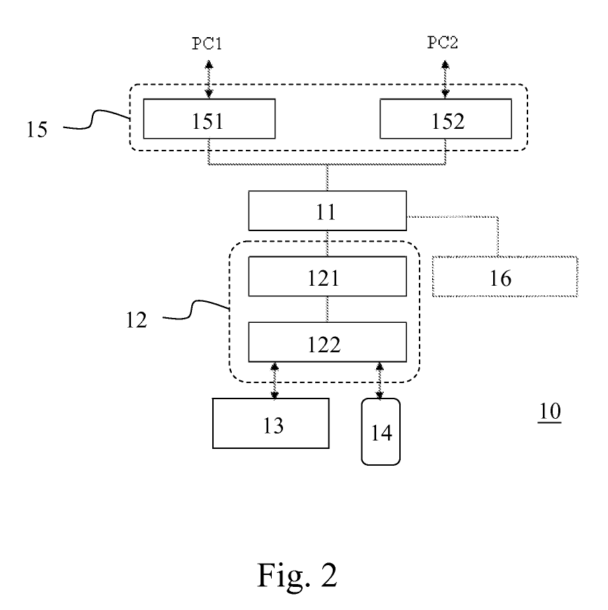

With reference to FIG. 2, which illustrates function blocks of the system of the present invention. The system 10 is used as a KM (keyboard/mouse) system which comprises a micro control unit 11; a first USB interface 12 coupled between the micro control unit 11 and a set of keyboard 13 and mouse 14; a second USB interface 15 coupled between the micro control unit 11 and a plurality of computers, for example, PC1 and PC2, with associated monitors; and a switching mechanism (not shown) for switching the set of keyboard 13 and mouse 14 coupled to one of the computers from another. Wherein the micro control unit 11 including a buffer (not shown) for registering a file from one of the computers (PC1) and then transferred to other one (PC2) of the computers. Generally speaking, the computers (PC1, PC2 . . . ) are coupled to the micro control unit 11 through the corresponding USB serial interface engines (SIE) (151, 152 . . . ) of the second USB interface 15. The system 10 can be coupled to two or more computers and transmitting the file between the computers through the buffer of the micro control unit 11.

The system 10 further comprises a video switch 16 coupled to the micro control unit 11. The video switch 16 is a DVI or a HDMI interface for outputting high resolution video signal from the computers controlled by the set of keyboard 13 and mouse 14.

Moreover, the first USB interface 12 is consisted of an USB host 121 coupled to the micro control unit 11 and a USB hub 122 coupled between the USB host 121 and the set of keyboard 13 and mouse 14. The switching mechanism is built in the micro control unit 11 for calculating boundaries of each monitors associated to the computers (PC1, PC2 . . . ) for switching the set of keyboard 13 and mouse 14 coupled to one of the computers from another. The switching mechanism further comprises a button or a switch that disposes on the system 10 for switching the set of keyboard 13 and mouse 14 coupled to one of the computers from another manually. Furthermore, the buffer is a memory with FIFO (first in first out) function.

If we remove all monitors associated to the computers and connect a monitor to the first USB interface 12, the system 10 can be used as a KVM (keyboard/video/mouse) system.

If an user wants to transfer a file from PC1 to PC2, the file will be registered in the buffer of the micro control unit 11 controlled by the user through the first USB interface 12, micro control unit 11 and the second USB interface 15 at first, after the switching mechanism switches the set of keyboard 13 and mouse 14 coupled from PC1 to PC2, the file registered in the buffer of the micro control unit 11 is transferred to PC2. If the user wants to transfer other files from PC1 to PC2, most files will be registered in the buffer (according to the capacity of the buffer) then transferred to PC2 in turn with FIFO.

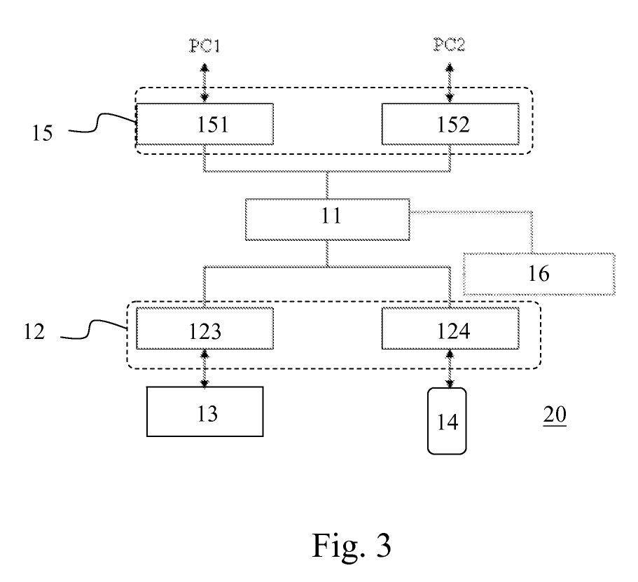

FIG. 3 illustrates another function blocks of the system of the present invention. The system 20 is similar to the system 10 shown in FIG. 2. The first USB interface 12 comprises two USB hosts 123, 124 for connecting to the set of keyboard 13 and mouse 14 for used as a KM system. Also, the first USB interface 12 comprises three USB hosts for connecting to the set of keyboard 13, monitor (not shown) and mouse 14 for used as a KVM system.

The system 20 can also comprise a video switch 16 coupled to the micro control unit 11. The video switch 16 is a DVI or a HDMI interface for outputting high resolution video signal from the computers controlled by the set of keyboard 13 and mouse 14.

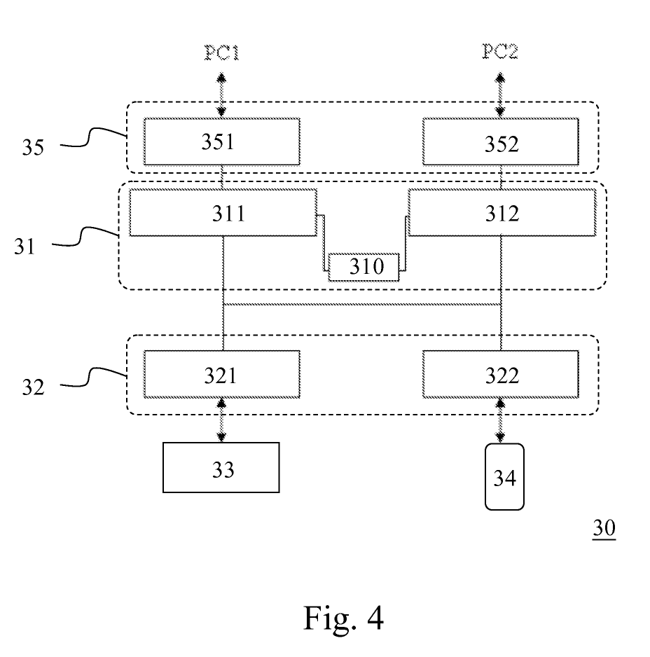

FIG. 4 illustrates further function blocks of the system of the present invention. The system 30 is used as a KM (keyboard/mouse) system which comprises a micro control unit 31; a first USB interface 32 coupled between the micro control unit 31 and a set of keyboard 33 and mouse 34; a second USB interface 35 coupled between the micro control unit 31 and a plurality of computers, for example, PC1 and PC2, with associated monitors; and a switching mechanism (not shown) for switching the set of keyboard 33 and mouse 34 coupled to one of the computers from another. The micro control unit 31 comprises a plurality of MCU cells 311, 312. Each of the MCU cells 311, 312 is connected to one of the USB serial interface engines (SIE) 351, 352 of the second USB interface 35. Therefore, the speed of data transfer rate from each of the computer and the system can be increased.

The micro control unit 11 including a buffer 310 coupled between the MCU cells 311, 312 for registering a file from one of the computers (PC1) and then transferred to other one (PC2) of the computers. Generally speaking, the computers (PC1, PC2 . . . ) are coupled to the micro control unit 11 through the corresponding USB serial interface engines (SIE) (351, 352 . . . ) of the second USB interface 35. If there are three or more computers (PC1, PC2 . . . ), the micro control unit 11 includes three or more corresponding MCU cells (311, 312 . . . ). Thus, the buffer 310 should be coupled to the MCU cells (311, 312 . . . ) for registering and transmitting the file between the computers (PC1, PC2 . . . ).

According to the present invention, there is no need to add data transfer units of the conventional KVM device. Files or datum can be transferred through MCU with buffer without increasing the cost and the size of the present system.

Moreover, the system 30 further comprises a network interface (not shown). The network interface includes at least three connection ports. The first connection port is coupled to PC1 by a first cable; the second connection port is coupled to PC2 by a second cable and a third connection port coupled to internet by a third port. Therefore, the system can be used as a network router for the PC1 and PC2 connecting to internet. The network interface can be also disposed in the system in FIG. 2 and FIG. 3 for connecting to internet.

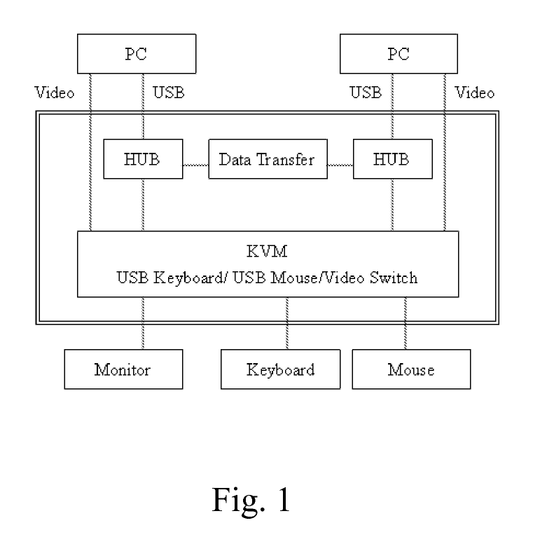

Furthermore, the system in FIG. 1 to FIG. 3 further comprises a card reading interface for reading contents of memory cards. The system can be used as a card reader by the card reading interface.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A system for transferring a file between associated computers comprising:
a micro control unit;
a first USB interface coupled between the micro control unit and a set of keyboard and mouse;
a second USB interface coupled between the micro control unit and a plurality computers with associated monitors; and
a switching mechanism built in the micro control unit for calculating boundaries of each monitors associated to the computers and switching the set of keyboard and mouse coupled to one of the computers to another;
wherein the micro control unit including a buffer for registering a file from one of the computers and then transferred to other one of the computers.

2. The system for transferring a file between associated computers according to claim 1, wherein the first USB interface is consisted of an USB host coupled to the micro control unit and a USB hub coupled between the USB host and the set of the set of keyboard and mouse.

3. The system for transferring a file between associated computers according to claim 1, wherein the first USB interface comprises two USB hosts for connecting to the set of keyboard and mouse.

4. The system for transferring a file between associated computers according to claim 1, wherein the system further comprises a video switch coupled to the micro control unit, and the interface of the video switch is DVI or HDMI.

5. The system for transferring a file between associated computers according to claim 1, wherein the buffer is a memory with first in first out function.

6. The system for transferring a file between associated computers according to claim 1, wherein the second USB interface comprises a plurality of USB serial interface engines for connecting the associated computers.

7. The system for transferring a file between associated computers according to claim 6, wherein the micro control unit comprises a plurality of MCU cells connected to one of the USB serial interface engines of the second USB interface.

8. The system for transferring a file between associated computers according to claim 1, wherein the switching mechanism further comprises a button or a switch disposed on the system for switching manually.

9. The system for transferring a file between associated computers according to claim 1, further comprises a network interface for connecting the computers to internet.

10. A system for transferring a file between associated computers comprising:
a micro control unit;
a first USB interface coupled between the micro control unit and a set of keyboard, monitor and mouse;
a second USB interface coupled between the micro control unit and a plurality computers; and
a switching mechanism for switching the set of keyboard, monitor and mouse coupled to on of the computers to another;
wherein the micro control unit including a buffer for registering a file from one of the computers and then transferred to other one of the computers.

11. The system for transferring a file between associated computers according to claim 10, wherein the first USB interface is consisted of an USB host coupled to the micro control unit and a USB hub coupled between the USB host and the set of the set of keyboard and mouse.

12. The system for transferring a file between associated computers according to claim 10, wherein the first USB interface comprises three USB hosts for connecting to the set of keyboard, monitor and mouse.

13. The system for transferring a file between associated computers according to claim 10, wherein the system further comprises a video switch coupled to the micro control unit, and the interface of the video switch is DVI or HDMI.

14. The system for transferring a file between associated computers according to claim 10, wherein the buffer is a memory with first in first out function.

15. The system for transferring a file between associated computers according to claim 10, wherein the second USB interface comprises a plurality of USB serial interface engines for connecting the associated computers.

16. The system for transferring a file between associated computers according to claim 15, wherein the micro control unit comprises a plurality of MCU cells connected to one of the USB serial interface engines of the second USB interface.

17. The system for transferring a file between associated computers according to claim 10, wherein the switching mechanism is a button or a switch disposed on the system.
